(19) United States
(12) Patent Application Publication
(10) Pub. No.: US 2014/0102318 A1
(43) Pub. Date: Apr. 17, 2014

(54) TOASTER

(71) Applicant: Tsann Kuen (ZHANGZHOU) Enterprise Co., Ltd., Zhang Zhou (CN)

(72) Inventors: Zhenwei CHEN, Zhang Zhou (CN); Wangji TONG, Zhang Zhou (CN); Shangqian GAO, Zhang Zhou (CN); Yen Tung LEE, Kaohsiung City (TW); Yu-Chuan LIN, New Taipei City (TW)

(73) Assignee: TSANN KUEN (ZHANGZHOU) ENTERPRISE CO., LTD., Zhang Zhou (CN)

(21) Appl. No.: 14/051,728

(22) Filed: Oct. 11, 2013

(30) Foreign Application Priority Data
Oct. 11, 2012 (CN) 201220527756.8

(51) Int. Cl. A47J 37/08

(52) U.S. Cl. CPC A47J 37/08
USPC 99/341

(57) ABSTRACT

The present invention is provided with a toaster, which comprising a housing, a longitudinal groove, a transparent movable baffle and a positioning mechanism. It can be observed from the exterior with the heating status of the toast, making it convenient to use. The movable baffle is sliding and connected to the longitudinal groove and positioned by the positioning mechanism, making it able to be drawn out of the housing to clean, so that the present invention is used with health, clean and it makes the food more delicious finally.

### FIELD OF THE INVENTION

The present invention relates to a toaster.

### BACKGROUND OF THE INVENTION

The traditional toaster adopts with non-transparent material, so people can't watch the interior operation status. Other toaster adopts transparent baffle of the heating cavity for observing the food inside the toaster, but the baffle of the heating cavity is unmovable. The dirt or the oil on the baffle can't be cleaned. The toaster needs to be improved.

### SUMMARY OF THE INVENTION

The present invention is provided with a toaster, which overcomes the disadvantages of the existing toaster. The technical proposal of the present invention to overcome the technical problems is below:

A toaster comprising:

a housing, which is disposed with an operation cavity and a heating cavity, one side of the housing is disposed with a first opening, the housing is disposed with at least one second opening, the operation cavity is connected to the heating cavity;

a longitudinal groove with same number with the second opening, the longitudinal groove is disposed inside the housing, the longitudinal groove is extended from the second opening;

at least one transparent movable baffle, which is sliding and connected to the longitudinal groove, the side face of the movable baffle is corresponding to the first opening; and

at least one positioning mechanism, which is fastened to the housing and positioned or supported the movable baffle.

In another preferred embodiment, the second opening is disposed in the bottom surface, the top surface, the left side surface or the right side surface of the housing.

In another preferred embodiment, the housing includes a base, the positioning mechanism includes a handle seat and a lock component rotated and connected to the handle seat, the lock component is locked to the seat or separated from the seat by rotating the lock component; the movable baffle is fixed to the handle seat.

In another preferred embodiment, an elastic component is disposed between the lock component and the handle seat.

In another preferred embodiment, the lock component is Z shaped.

In another preferred embodiment, the housing is further disposed with a groove, the positioning mechanism is coupled to the groove.

In another preferred embodiment, the movable baffle is made of glass.

In another preferred embodiment, the number of the second opening is one, the number of the movable baffle is one.

In another preferred embodiment, the number of the second opening is two, the two second openings are separately disposed in the bottom surface and the top surface or in the left side surface and the right side surface of the housing, the number of the movable baffle is two.

Compared to the existing technology, the technical proposal of the present invention has advantages as below:

1. The first opening is corresponding to the side surface of the transparent movable baffle, it can be observed from the exterior with the heating status of the toast, making it convenient to use. The movable baffle is sliding and connected to the longitudinal groove and positioned by the positioning mechanism, making it able to be drawn out of the housing to clean, so that the present invention is used with health, clean and it makes the food more delicious finally.

2. The second opening can be disposed in the bottom surface, the top surface, the right side or the left side of the housing, making the movable baffle able to be drawn out from the up, down, left or right direction. It's easy to use and convenient.

3. The positioning mechanism includes a handle seat and a lock component rotated and connected to the handle seat, the lock component is locked to the base or separated from the base by rotating the lock component. The positioning mechanism is simple structured with low cost, and the positioning is firm.

### BRIEF DESCRIPTION OF THE DRAWINGS

The present invention will be further descried with the drawings and the embodiments.

FIG. 1 illustrates the toaster of the first embodiment when the movable baffle is being drawn out;

FIG. 2 illustrates another status of the toaster of the first embodiment when the movable baffle is being drawn out;

FIG. 3 illustrates the front view of the positioning mechanism of the toaster of the first embodiment;

FIG. 4 illustrates the back view of the positioning mechanism of the toaster of the first embodiment;

FIG. 5 illustrates the first sectional view of the positioning mechanism of the toaster of the first embodiment;

FIG. 6 illustrates the second sectional view of the positioning mechanism of the toaster of the first embodiment;

FIG. 7 illustrates the third sectional view of the positioning mechanism of the toaster of the first embodiment;

FIG. 8 illustrates the breakdown structure of the toaster of the second embodiment;

FIG. 9 illustrates the breakdown structure of the toaster of the third embodiment;

FIG. 10 illustrates the breakdown structure of the toaster of the fourth embodiment;

FIG. 11 illustrates the breakdown structure of the toaster of the fifth embodiment;

FIG. 12 illustrates the breakdown structure of the toaster of the sixth embodiment.

### DETAILED DESCRIPTION OF THE EMBODIMENT

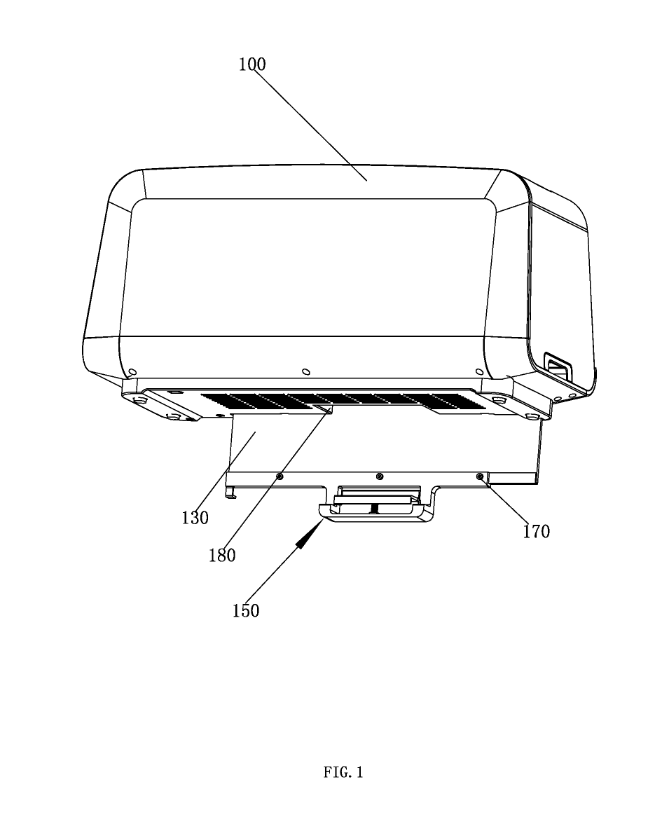

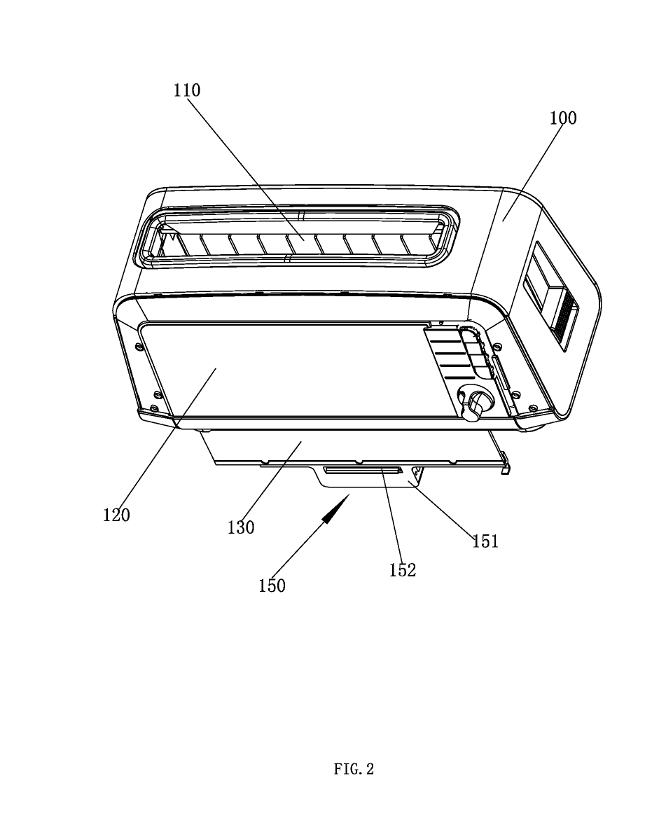

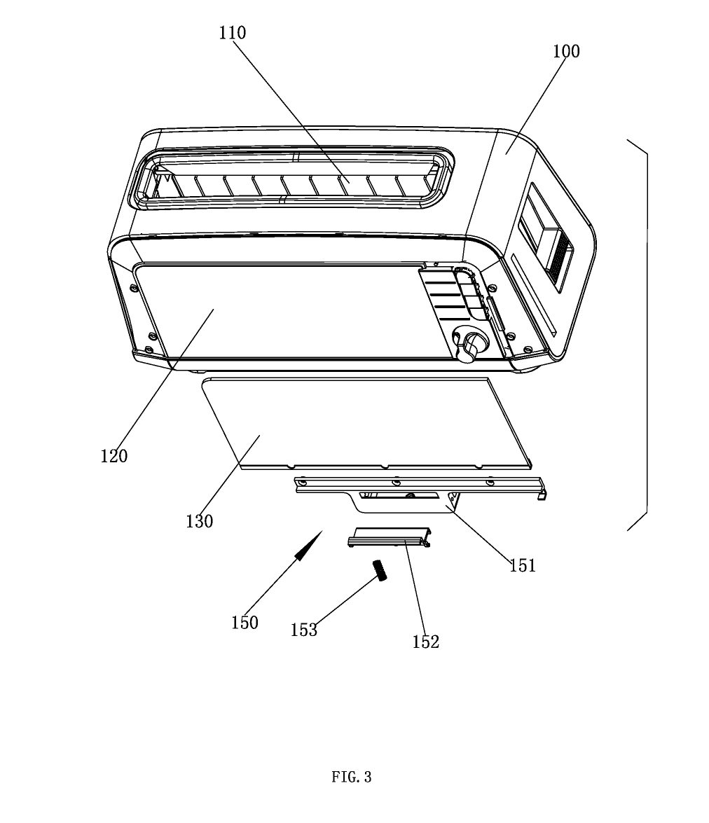

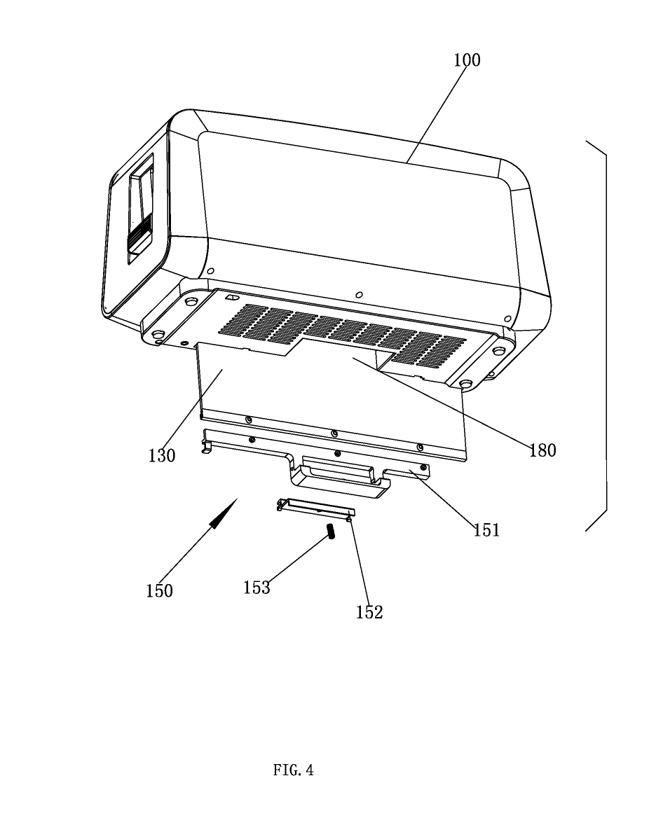

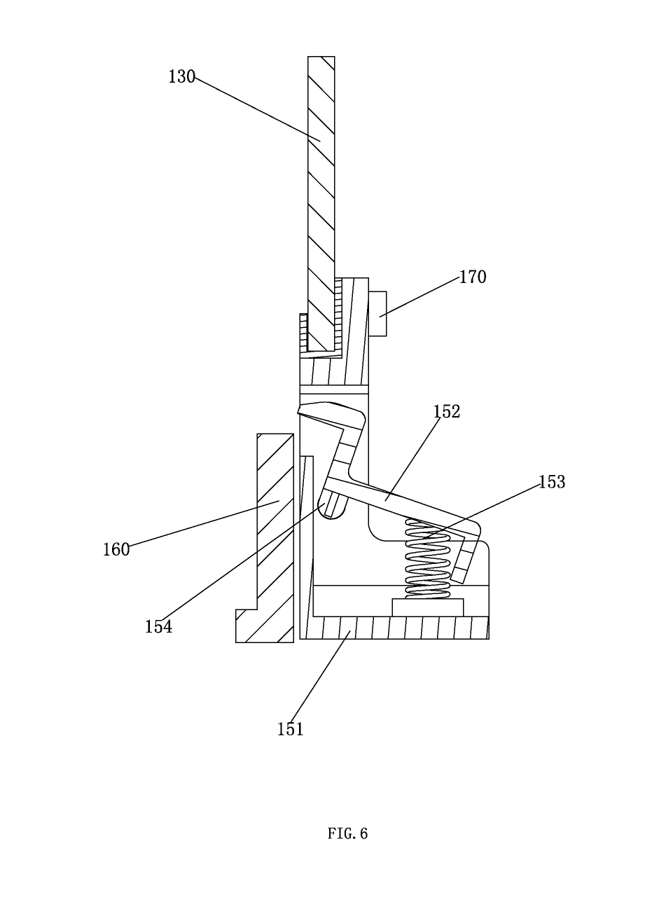

Refer to the FIG. 1 to FIG. 7. A toaster of the first embodiment includes a housing 100, a heating cavity 110, an operation cavity, a movable baffle 130 and a positioning mechanism 150.

The housing 100 is disposed with the operation cavity and the heating cavity 110 inside. One side of the housing 100 is disposed with a first opening 120. The housing 100 is disposed with at least one second opening. The operation cavity is connected to the heating cavity 110. The housing 100 is disposed with a longitudinal groove with same number with the second opening. The longitudinal groove is extended from the second opening. Preferred, the first opening is disposed with a piece of glass.

The movable baffle 130 is transparent and it is sliding and connected to the longitudinal groove. The side surface of the movable baffle 130 is corresponding to the first opening 120. People can watch the food through the first opening 120 and the transparent movable baffle 130 from the exterior of the toaster to know the heating state of the food conveniently. In this embodiment, there is one movable baffle 130. The number of the movable baffle 130 can be adjusted as required. The movable baffle 130 can be moved out from the housing to clean, so that the present invention is used with health, clean and it makes the food more delicious finally.

In this embodiment, the second opening is disposed at the bottom of the housing 100, the longitudinal groove is extended from the second opening and disposed in the front side of the heating cavity 110. The movable baffle 130 can be removed from the bottom of the housing 100, and it will not influence the appearance of the machine. As required, the second opening can be disposed in the two side surfaces or the top surface of the housing 100, making the movable baffle 130 able to be removed from the top, the left side or the right side of the housing. There can be two movable baffles disposed in the front and back sides of the heating cavity 110.

The positioning mechanism 150 is fastened to the housing 100 to be positioned and supported the movable baffle 130. In this embodiment, the housing 100 is further disposed with a base 160 inside. The positioning mechanism 150 is locked to the base 160. The positioning mechanism 150 includes a handle seat 151 and a lock component 152 rotated and connected to the handle seat 151, the rotation shaft 154 is disposed in the lock component 152, the lock component 152 is locked to the base 160 or separated from the base 150 by rotating the lock component 152. The movable baffle 130 is fixed to the handle seat 151. In this embodiment, the movable baffle 130 is connected to the handle seat 151 by a bolt 170 and the handle seat 151 is disposed below the movable baffle 130. The lock component 152 is Z shaped. Preferred, an elastic component 153 is disposed between the lock component 152 and the handle seat 151 to enhance the hand feel.

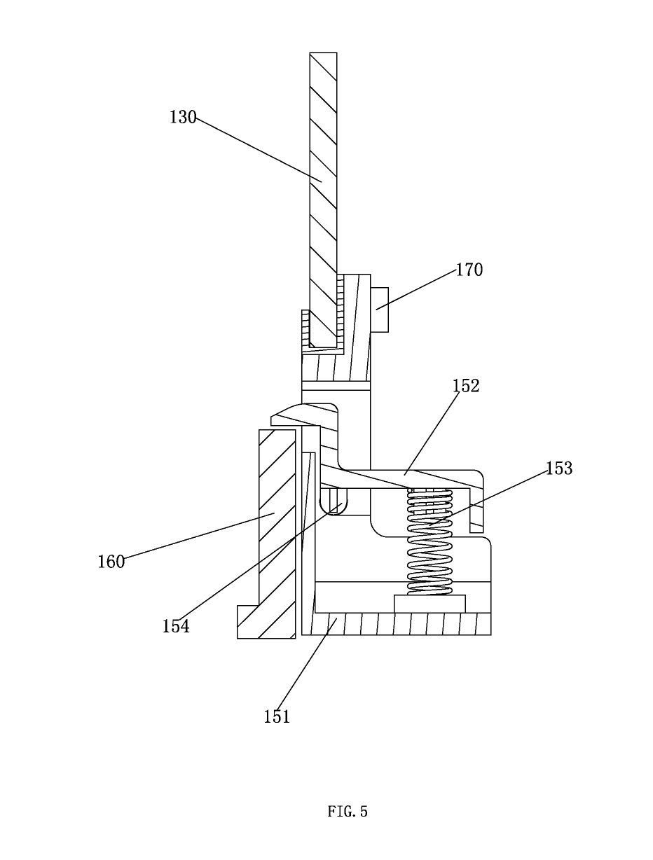

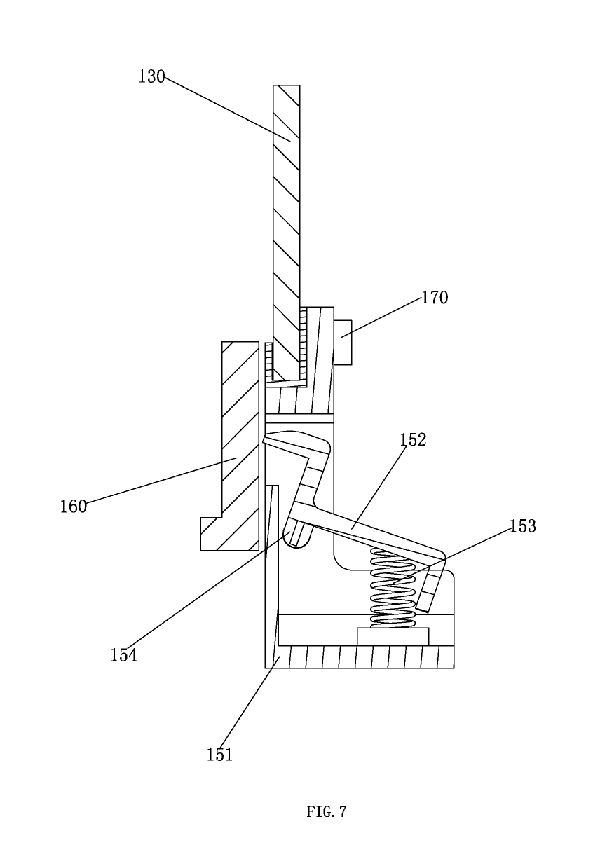

Refer to the FIG. 5 to the FIG. 7. to remove the movable baffle 130 to wash, press the lock component 152 to make the elastic component 153 elastic deforming, at the same time, the lock component 152 is driven to rotate about the rotation shaft 154 to make the lock component 152 separated from the base 160, then what is needed to do is to draw out the movable baffle 130 from the bottom of the housing 100. The positioning mechanism is simple structured with low cost, and the positioning is firm. A groove 180 is disposed in the bottom surface of the housing 100, and the positioning mechanism 150 is coupled to the groove 180. The bottom surface of the positioning mechanism 150 is parallel to the bottom surface of the housing 100, making the entire positioning mechanism 150 hiding at the bottom of the toaster to ensure it look well.

In this embodiment, the movable baffle 130 is made of glass. It can be observed from the exterior with the heating status of the toast, making it convenient to use. Preferred, a thermal insulation glass is disposed between the movable baffle 130 and the side surface of the housing 100 to prevent scald and security risk.

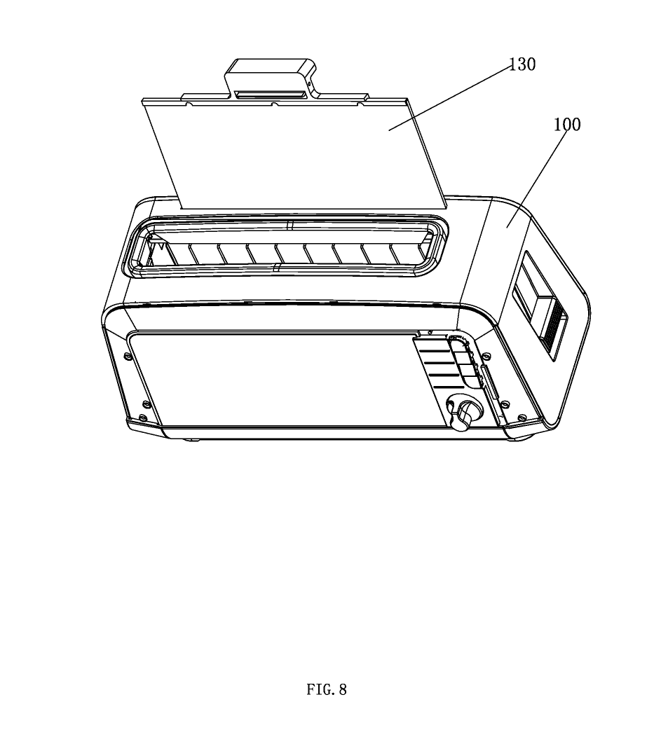

As figured in the FIG. 8 of the second embodiment of the toaster, there is one second opening disposed in the top surface of the housing 100. The number of the longitudinal groove is one and it is extended from the second opening. The number of the movable baffle 130 is one, and it can be drawn out from the top of the housing 100.

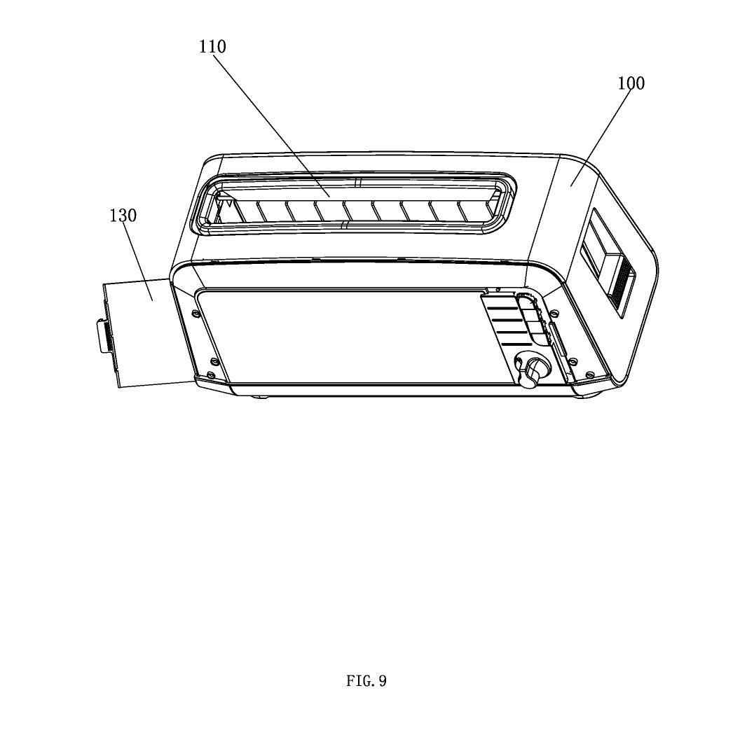

As figured in the FIG. 9 of the third embodiment of the toaster, there is one second opening disposed in the left side of the housing 100. The number of the longitudinal groove is one and it is extended from the second opening. The number of the movable baffle 130 is one, and it can be drawn out from the left side of the housing 100.

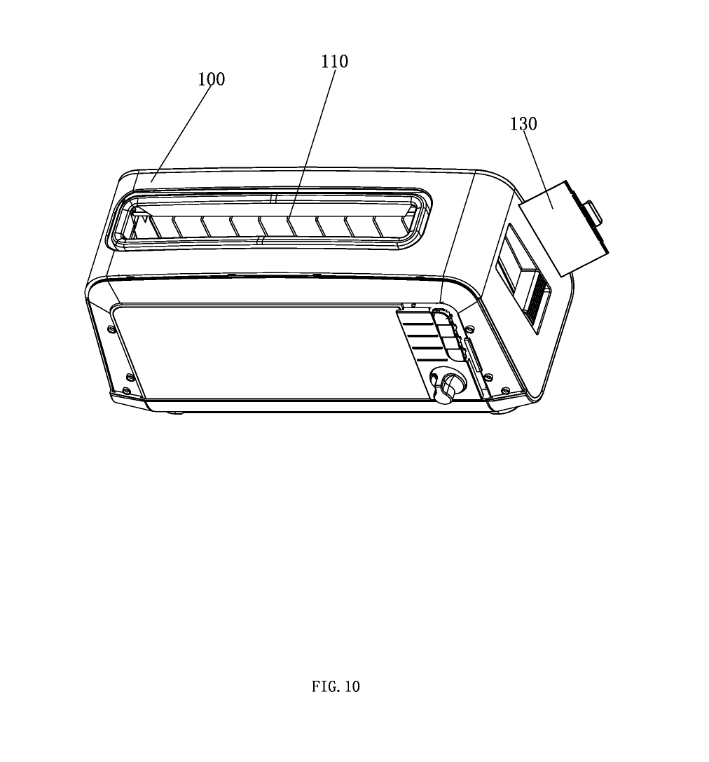

As figured in the FIG. 10 of the forth embodiment of the toaster, there is one second opening disposed in the right side of the housing 100. The number of the longitudinal groove is one and it is extended from the second opening. The number of the movable baffle 130 is one, and it can be drawn out from the right side of the housing 100.

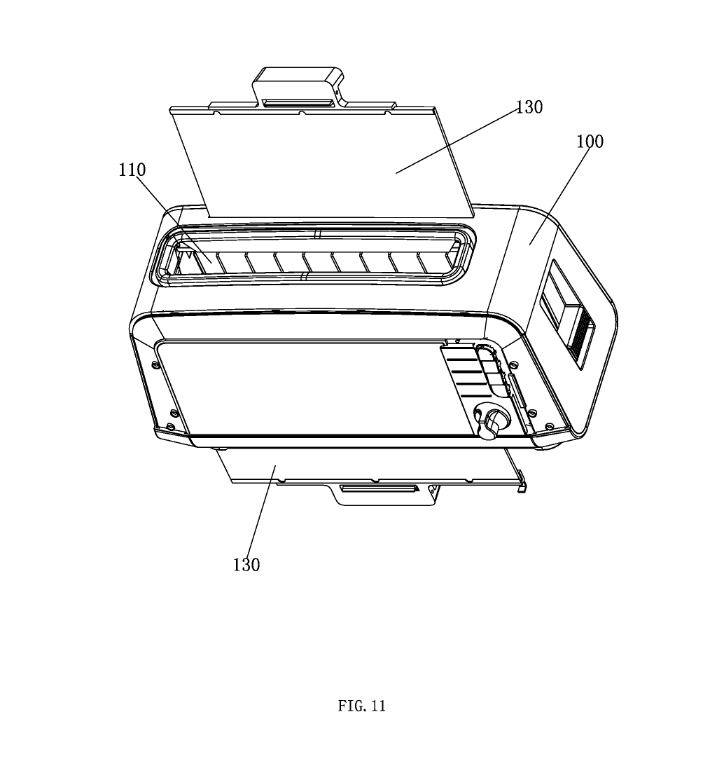

As figured in the FIG. 11 of the fifth embodiment of the toaster, there are two second openings separately disposed in the top surface and the bottom surface of the housing 100. The number of the longitudinal groove is two and they are separately extended from the two second openings. The number of the movable baffle 130 is two, and they are separately disposed in the front and the back side of the heating cavity 110. One of the movable baffles 130 can be drawn out from the top of the housing 100, while the other one can be drawn out from the bottom of the housing 100. As required, the two second openings can be disposed in the top surface or the bottom surface of the housing 100.

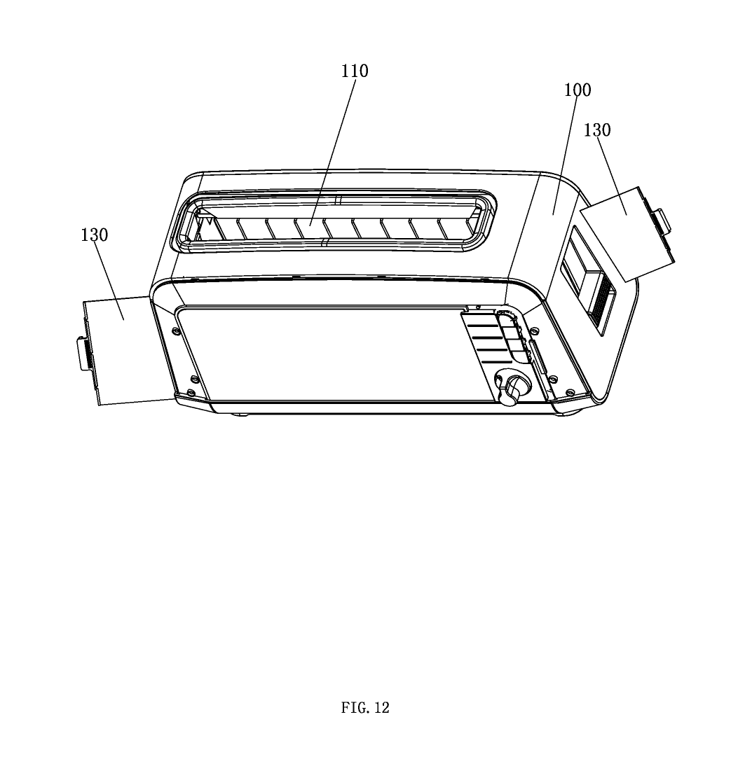

As figured in the FIG. 12 of the sixth embodiment of the toaster, there are two second openings separately disposed in the right and left sides of the housing 100. The number of the longitudinal groove is two and they are separately extended from the two second openings. The number of the movable baffle 130 is two, and they are separately disposed in the front and the back side of the heating cavity 110. One of the movable baffles 130 can be drawn out from the left side of the housing 100, while the other one can be drawn out from the right side of the housing 100. As required, the two second openings can be both disposed in the left side or the right side of the housing 100. In other embodiment, there are two second openings; one of the second openings is disposed in the left side or the right side of the housing 100, while the other one is disposed in the top surface or the bottom surface of the housing 100.

In another embodiment, the number of the second openings is four and they are separately disposed in the top surface, the bottom surface, the left side and the right side of the housing 100. The number of the movable baffle 130 is four and they can be separately drawn out from the left, right, up and below direction. As required, the number of the movable baffle 130 and the drawing direction can be adjusted without limited.

Although the present invention has been described with reference to the preferred embodiments thereof for carrying out the patent for invention, it is apparent to those skilled in the art that a variety of modifications and changes may be made without departing from the scope of the patent for invention which is intended to be defined by the appended claims.

1. A toaster comprising:
a housing, which is disposed with an operation cavity and a heating cavity, one side of the housing is disposed with a first opening, the housing is disposed with at least one second opening, the operation cavity is connected to the heating cavity;
a longitudinal groove with same number with the second opening, the longitudinal groove is disposed inside the housing, the longitudinal groove is extended from the second opening;
at least one transparent movable baffle, which is sliding and connected to the longitudinal groove, the side face of the movable baffle is corresponding to the first opening; and
at least one positioning mechanism, which is fastened to the housing and positioned or supported the movable baffle.

2. A toaster according to the claim 1, wherein the second opening is disposed in the bottom surface, the top surface, the left side surface or the right side surface of the housing.

3. A toaster according to the claim 1, wherein the housing includes a base, the positioning mechanism includes a handle seat and a lock component rotated and connected to the handle seat, the lock component is locked to the seat or separated from the seat by rotating the lock component; the movable baffle is fixed to the handle seat.

4. A toaster according to the claim 3, wherein an elastic component is disposed between the lock component and the handle seat.

5. A toaster according to the claim 3, wherein the lock component is Z shaped.

6. A toaster according to the claim 2, wherein the housing is further disposed with a groove, the positioning mechanism is coupled to the groove.

7. A toaster according to the claim 1, wherein the movable baffle is made of glass.

8. A toaster according to the claim 2, wherein the number of the second opening is one, the number of the movable baffle is one.

9. A toaster according to claim 2, wherein the number of the second opening is two, the two second openings are separately disposed in the bottom surface and the top surface or in the left side surface and the right side surface of the housing, the number of the movable baffle is two.

10. A toaster according to the claim 2, wherein the movable baffle is made of glass.

11. A toaster according to the claim 3, wherein the movable baffle is made of glass.

12. A toaster according to the claim 4, wherein the movable baffle is made of glass.

13. A toaster according to the claim 5, wherein the movable baffle is made of glass.

14. A toaster according to the claim 6, wherein the movable baffle is made of glass.
